(19) United States
(12) Patent Application Publication
(10) Pub. No.: US 2023/0212980 A1
(43) Pub. Date: Jul. 6, 2023

(54) PLANT MONITORING DEVICE, PLANT MONITORING METHOD, AND PROGRAM

(71) Applicant: Mitsubishi Power, Ltd., Yokohama-shi, Kanagawa (JP)

(72) Inventors: Ichiro NAGANO, Yokohama-shi (JP); Mayumi SAITO, Tokyo (JP); Keiji EGUCHI, Tokyo (JP); Kuniaki AOYAMA, Takasago City (JP)

(21) Appl. No.: 17/928,466

(22) PCT Filed: May 31, 2021
(86) PCT No.: PCT/JP2021/020739

§ 371 Date: Nov. 29, 2022

(30) Foreign Application Priority Data
Jun. 12, 2020 (JP) 2020-102395

(51) Int. Cl. F02C 7/00; F01D 25/00; G05B 19/042

(52) U.S. Cl. CPC F02C 7/00; F01D 25/00; G05B 19/0428; F05D 2220/32; F05D 2260/80; F05D 2260/83; G05B 2219/41108

(57) ABSTRACT

An acquisition unit acquires a bundle of detection values for each of a plurality of sensor values pertaining to a plant. A distance calculation unit obtains the Mahalanobis distance of the bundle of detection values acquired by the acquisition unit using, as reference, a unit space constituted by a collection of bundles of detection values for each of the plurality of sensor values. A determining unit determines, based on whether the Mahalanobis distance is at or within a prescribed threshold, whether the operation state of the plant is normal or abnormal. A trend specification unit specifies a trend with regards to at least one sensor value. An abnormality cause estimation unit estimates an abnormality cause based on the trend for the sensor value(s), and a fault site estimation database for holding the relationship between abnormality causes that may occur in the plant and sensor values for each of the trends.

### TECHNICAL FIELD

The present disclosure relates to a plant monitoring device, a plant monitoring method, and a program that monitors an operation state of a plant.

Priority is claimed on Japanese Patent Application No. 2020-102395 filed on Jun. 12, 2020, the content of which is incorporated herein by reference.

### BACKGROUND ART

In various types of plants, such as a gas turbine power generation plant, a nuclear power generation plant, and a chemical plant, whether a plant is normally operated is monitored. Therefore, state quantities of each sensor of the plant, such as a temperature and a pressure, are acquired, and an operation state of the plant is monitored based on the state quantities. However, in a case where an abnormality has occurred, a cause estimation function is required.

For example, a monitoring device of PTL 1 below acquires a state quantity of each sensor of the plant online from a computer of the plant and determines whether or not the state quantity is abnormal using the Mahalanobis Taguchi method (hereinafter, referred to as the MT method). The monitoring device has, when it is determined that there is an abnormality, a function of identifying a cause of the abnormality.

In the MT method, a unit space configured by collecting a plurality of bundles of state quantities, which are collections of state quantities for each of a plurality of sensors, is prepared in advance. When a bundle of state quantities is acquired from the plant, a Mahalanobis distance (hereinafter, referred to as an MD distance) of the bundle of state quantities is acquired with the unit space as reference. Whether or not the operation state of the plant is normal is determined according to whether or not the Mahalanobis distance is within a threshold value determined in advance.

### CITATION LIST

### Patent Literature

[PTL 1] Japanese Unexamined Patent Application Publication No. 2017-215863

### SUMMARY OF INVENTION

### Technical Problem

In the MT method, a sensor having an increased Mahalanobis distance can be identified by calculating a larger-the-better SN ratio for each sensor based on the Mahalanobis distance. When focusing on one sensor in the MT method of the related art, in both a case where the sensor shows a high value and a case where the sensor shows a low value, the Mahalanobis distance increases. Thus, high value/low value abnormalities cannot be distinguished.

An object of the present disclosure is to provide a reliable failure part estimation database creating method and a reliable abnormality cause estimating method in which information of causes of an abnormality which has a high value/low value and is likely to occur and an abnormality which has a high value/low value and is unlikely to occur are added.

### Solution to Problem

According to an aspect of the invention, there is provided a plant monitoring device having an acquisition unit that acquires a bundle of detection values for each of a plurality of sensor values related to a plant, a distance computing unit that acquires a Mahalanobis distance of the bundle of detection values acquired by the acquisition unit with a unit space configured by collecting the bundle of detection values for each of the plurality of sensor values as reference, a determination unit that determines whether an operation state of the plant is normal or abnormal according to whether or not the Mahalanobis distance is within a predetermined threshold value, and a determination unit that determines, for each sensor value, whether a larger-the-better SN ratio has occurred because of a high value or a low value.

According to one aspect, a failure part estimation database is realized by adding information of whether a specific abnormality cause is likely to occur because of a high value abnormality of a sensor or is likely to occur because of a low value abnormality and whether an abnormality cause is less likely to occur because of a high value abnormality of a sensor value or is less likely to occur because of a low value abnormality.

According to one aspect, an abnormality cause can be more reliably estimated by combining distinction between high value/low value abnormalities of a larger-the-better SN ratio with information of whether a specific abnormality cause is likely to occur or is less likely to occur because of a high value/low value abnormality of a sensor value as the failure part estimation database of the present invention.

### Advantageous Effects of Invention

According to at least one of the aspects, the plant monitoring device can more reliably estimate a true cause of a failure by setting information of an event having a low probability that a cause occurs because of an abnormality of a sensor to a negative value.

### BRIEF DESCRIPTION OF DRAWINGS

FIG. 1 is a diagram for describing an outline of a plant monitoring device according to a first embodiment.

FIG. 2 is a schematic block diagram showing a functional configuration of the plant monitoring device according to the first embodiment.

FIG. 3 is a table showing an example of a failure part estimation database according to the first embodiment.

FIG. 4 is a conceptual diagram showing the concept of a Mahalanobis distance.

FIG. 5 is a flowchart showing a method of updating the failure part estimation database according to the first embodiment.

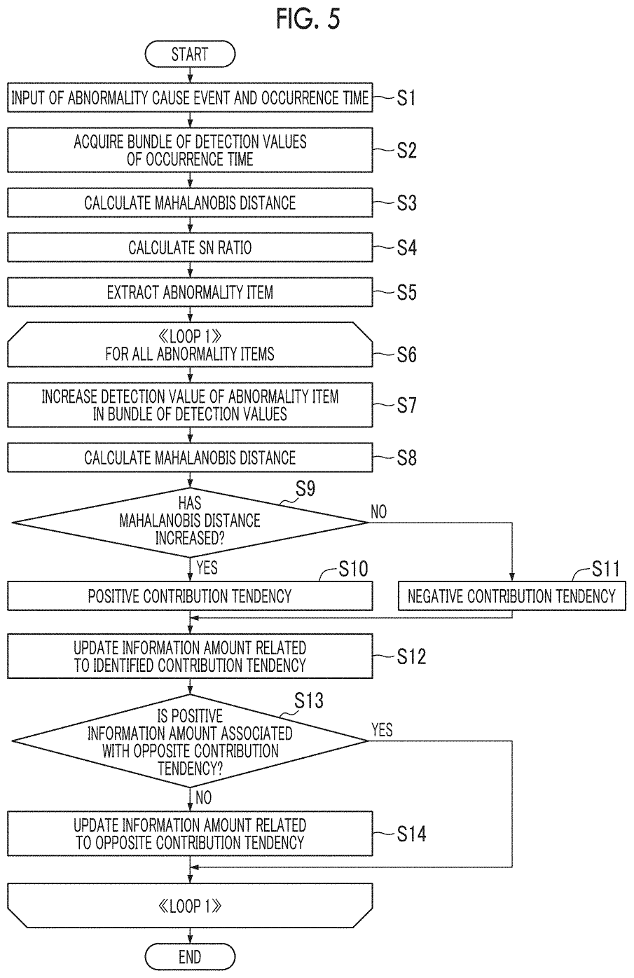

FIG. 6 is a flowchart showing monitoring processing of a plant according to the first embodiment.

FIG. 7 is a schematic block diagram showing a configuration of a computer according to at least one embodiment.

### DESCRIPTION OF EMBODIMENTS

### First Embodiment

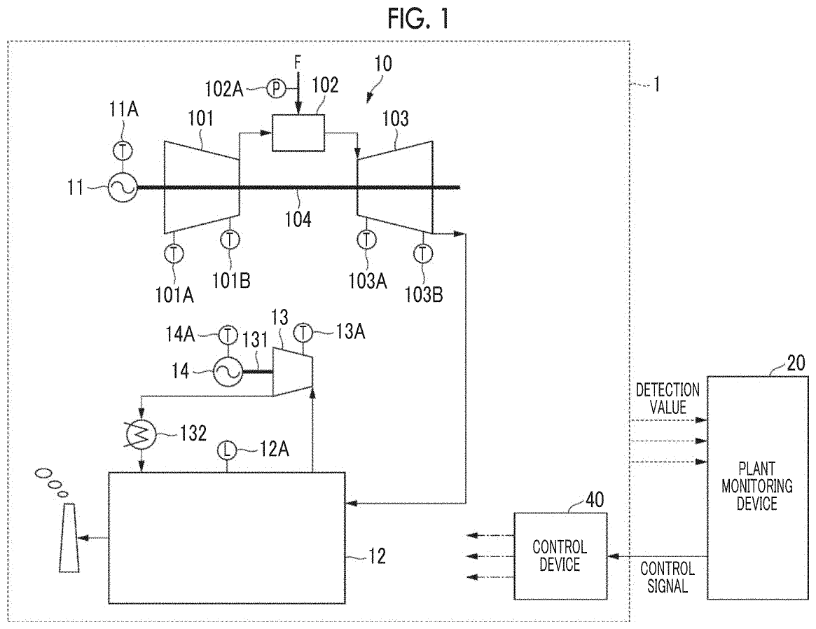

FIG. 1 is a diagram for describing an outline of a plant monitoring device 20 according to a first embodiment.

The plant monitoring device 20 according to the present embodiment is a device for monitoring an operation state of a plant 1 which includes a plurality of evaluation items. The plant monitoring device 20 acquires a detection value indicating a state quantity for each evaluation item from a detector provided in each part of the plant 1. The plant monitoring device 20 determines whether the operation state of the plant 1 is normal or abnormal based on the acquired detection value using the Mahalanobis Taguchi method.

<<Configuration of Plant>>

The plant 1 according to the present embodiment is a gas turbine combined power generation plant and includes a gas turbine 10, a gas turbine generator 11, a heat recovery steam generator 12, a steam turbine 13, a steam turbine generator 14, and a control device 40. In other embodiments, the plant 1 may be a gas turbine power generation plant, a nuclear power generation plant, or a chemical plant.

The gas turbine 10 includes a compressor 101, a combustor 102, and a turbine 103.

The compressor 101 compresses air taken in from a suction port. The compressor 101 is provided with temperature sensors 101A and 101B as detectors for detecting a temperature in an interior chamber of the compressor 101, which is one of the evaluation items. For example, the temperature sensor 101A may detect the temperature of an interior chamber inlet of the compressor 101 (inlet air temperature), and the temperature sensor 101B may detect the temperature of an interior chamber outlet (outlet air temperature).

The combustor 102 mixes a fuel F with compressed air introduced from the compressor 101 to combust the mixture and generates a combustion gas. The combustor 102 is provided with a pressure sensor 102A as a detector for detecting the pressure of the fuel F, which is one of the evaluation items.

The turbine 103 is rotationally driven by the combustion gas supplied from the combustor 102. The turbine 103 is provided with temperature sensors 103A and 103B as detectors for detecting a temperature in the interior chamber, which is one of the evaluation items. For example, the temperature sensor 103A may detect the temperature of an interior chamber inlet of the turbine 103 (inlet combustion gas temperature), and the temperature sensor 103B may detect the temperature of an interior chamber outlet (outlet combustion gas temperature).

The gas turbine generator 11 is connected to a rotor of the turbine 103 via the compressor 101 and generates power through the rotation of the rotor. The gas turbine generator 11 is provided with a thermometer 11A as a detector for detecting the temperature of a lubricant, which is one of the evaluation items.

The heat recovery steam generator 12 heats water with a combustion gas (exhaust gas) exhausted from the turbine 103 and generates steam. The heat recovery steam generator 12 is provided with a level meter 12A as a detector for detecting a water level of a drum, which is one of the evaluation items.

The steam turbine 13 is driven by the steam from the heat recovery steam generator 12. The steam turbine 13 is provided with a temperature sensor 13A as a detector for detecting a temperature in the interior chamber, which is one of the evaluation items. In addition, the steam exhausted from the steam turbine 13 is converted back to water by a condenser 132 and is sent to the heat recovery steam generator 12 via a water supply pump.

The steam turbine generator 14 is connected to a rotor 131 of the steam turbine 13 and generates power through the rotation of the rotor 131. The steam turbine generator 14 is provided with a thermometer 14A as a detector for detecting the temperature of a lubricant, which is one of the evaluation items.

The evaluation items described above are examples and are not limited thereto. For example, an output of the gas turbine generator 11, a pressure in the interior chamber of the turbine 103, and the rotation speed and vibration of the rotor of the turbine 103 or the steam turbine 13 may be set as other evaluation items of the plant 1. In this case, a detector (not shown) that detects each of the state quantities of the evaluation items is provided in each part of the plant 1.

The control device 40 is a device for controlling an operation of the plant 1. In addition, in a case where the plant monitoring device 20 determines that the operation state of the plant 1 is abnormal, the control device 40 may control an operation of each part of the plant 1 in accordance with a control signal from the plant monitoring device 20.

<<Configuration>>

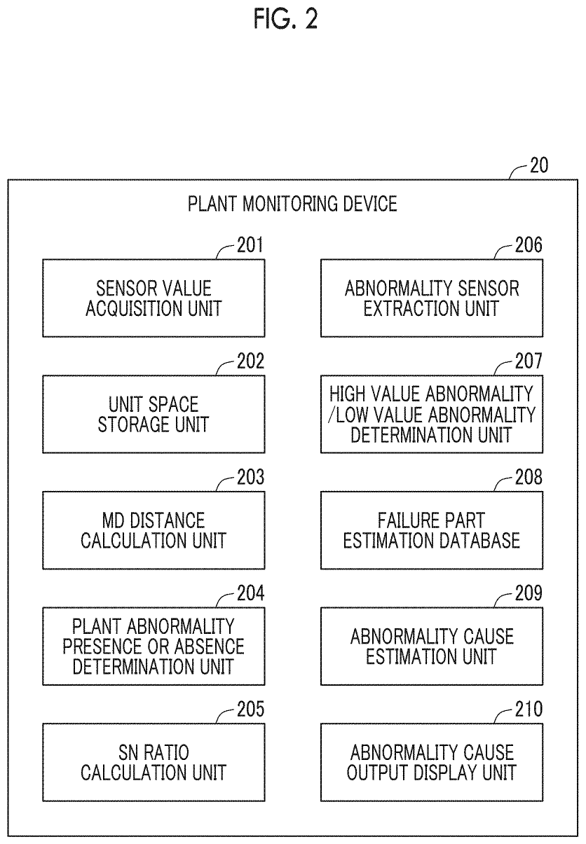

FIG. 2 is a schematic block diagram showing a functional configuration of the plant monitoring device 20 according to the first embodiment.

The plant monitoring device 20 includes a sensor value acquisition unit 201, a unit space storage unit 202, an MD distance calculation unit 203, a plant abnormality presence or absence determination unit 204, a larger-the-better SN ratio calculation unit 205, an abnormality sensor extraction unit 206, a high value abnormality/low value abnormality determination unit 207, a failure part estimation database 208, an abnormality cause estimation unit 209, and an abnormality cause output display unit 210.

The sensor value acquisition unit 201 acquires a detection value from each of a plurality of detectors provided in the plant 1. Each detector corresponds to each of the plurality of evaluation items. That is, the sensor value acquisition unit 201 acquires a bundle of detection values, which is a collection of detection values for each of the plurality of evaluation items. The sensor value acquisition unit 201 acquires a bundle of detection values every predetermined acquisition cycle (for example, one minute) and records the bundle in the unit space storage unit.

The unit space storage unit 202 stores a combination of bundles of detection values acquired from a normal plant as a unit space of a Mahalanobis distance.

The MD distance calculation unit 203 calculates a Mahalanobis distance indicating the state of the plant 1 based on the unit space stored by the unit space storage unit 202, with the bundles of detection values acquired by the sensor value acquisition unit 201 as the specifications. The Mahalanobis distance is a measure showing the size of a difference between a reference sample expressed as a unit space and a newly obtained sample.

The plant abnormality presence or absence determination unit 204 determines whether or not an abnormality has occurred in the plant 1 based on the Mahalanobis distance calculated by the MD distance calculation unit 203. Specifically, in a case where the Mahalanobis distance is equal to or larger than a predetermined threshold value, the plant abnormality presence or absence determination unit 204 determines that an abnormality has occurred in the plant 1. The threshold value is usually set to a value of 3 or larger.

In a case where the plant abnormality presence or absence determination unit 204 determines that an abnormality has occurred in a gas turbine T, the larger-the-better SN ratio calculation unit 205 calculates a larger-the-better signal-noise ratio (SN ratio) according to the Taguchi method based on the bundle of detection values acquired by the sensor value acquisition unit 201. For example, the larger-the-better SN ratio calculation unit 205 acquires a larger-the-better SN ratio with or without items based on orthogonal array analysis. It can be determined that as the larger-the-better SN ratio increases, a probability that there is an abnormality in the evaluation item related to the detection value increases.

The abnormality sensor extraction unit 206 extracts at least one abnormality sensor showing a sensor value which has made a high contribution to an increase in the Mahalanobis distance based on the larger-the-better SN ratio calculated by the larger-the-better SN ratio calculation unit 205. The abnormality sensor extraction unit 206 may extract, for example, a predetermined number of higher sensor values having high larger-the-better SN ratios, among a plurality of sensor values, as abnormality sensors. In addition, for example, the abnormality sensor extraction unit 206 may extract a sensor value having a larger-the-better SN ratio which is equal to or larger than a predetermined threshold value, among a plurality of sensor values, as an abnormality sensor.

The high value abnormality/low value abnormality determination unit 207 identifies, for each of a plurality of sensor values, whether an abnormality that has occurred is a high value abnormality, which is an abnormality caused by a high detection value, which is a sensor value, or a low value abnormality, which is an abnormality caused by a low detection value. That is, the high value abnormality/low value abnormality determination unit 207 identifies whether an increase in the Mahalanobis distance is caused by an increase in the detection value or is caused by a decrease in the detection value. Specifically, the high value abnormality/low value abnormality determination unit 207 calculates a Mahalanobis distance when a value of a bundle of detection values acquired by the sensor value acquisition unit 201 is increased or decreased for each sensor value and identifies whether an abnormality is a high value abnormality or a low value abnormality based on an increase or a decrease in the Mahalanobis distance caused by a change in the value. In a case where an increase in the Mahalanobis distance has occurred due to an increase in the detection value, it is understood that the sensor value has a high value abnormality. In a case where an increase in the Mahalanobis distance has occurred due to a decrease in the detection value, it is understood that the sensor value has a low value abnormality. (Japanese Patent Application No. 2019-063575)

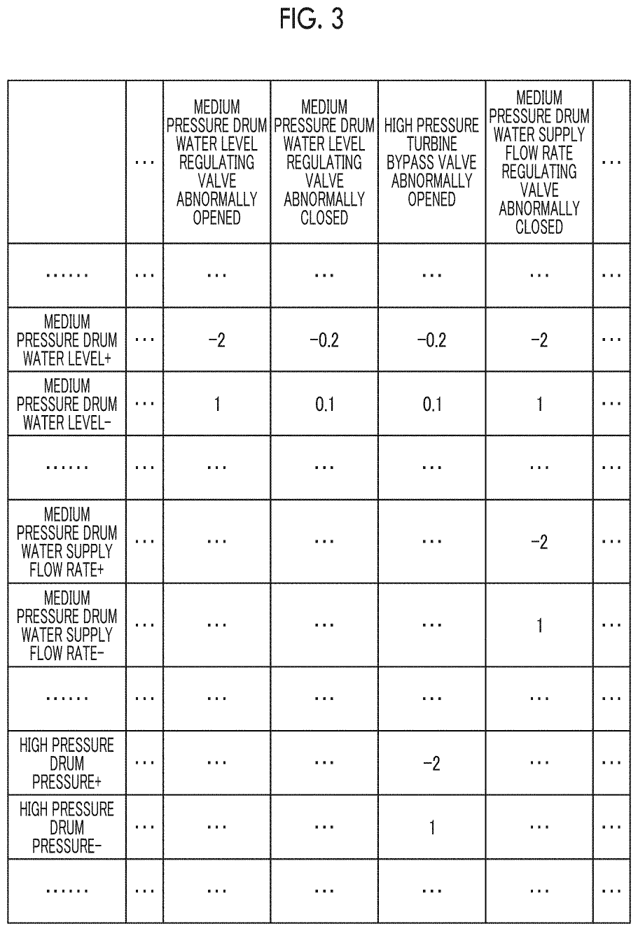

The failure part estimation database 208 is a failure part estimation database showing a relationship between an evaluation item, an abnormality cause, and distinction between a high value abnormality and a low value abnormality. FIG. 3 is a table showing an example of the failure part estimation database according to the first embodiment. Specifically, the failure part estimation database contains, for each evaluation item related to a high value abnormality and a low value abnormality (vertical column of FIG. 3) and for each abnormality cause (horizontal column of FIG. 3), when the abnormality cause has occurred, an information amount about the presence of an abnormality associated with the evaluation item. When the same abnormality is found in the associated evaluation item as the value of the information amount increases, an information amount related to a high value abnormality or a low value abnormality, which has actually occurred, among information amounts stored by the failure part estimation database 208, is expressed by, for example, the following equation (1).

[Equation 1]

I=log₂[Σ(x*w)+1]/log₂(2) (1)

Herein, I indicates the information amount, x indicates the number of events that have occurred, and w indicates a weighting coefficient based on data reliability.

For example, the weighting coefficient w when an abnormality cause actually occurs and an abnormality cause is identified based on a report thereof may be higher than the weighting coefficient w when the abnormality cause is identified based on FTA data (FT: Fault Tree) generated by maintenance personnel. In addition, the weighting coefficient w when an abnormality cause is identified based on a method with higher accuracy than the report, such as offline analysis and simulation, may be higher than the weighting coefficient w when an abnormality cause actually occurs and the abnormality cause is identified based on a report thereof.

On the other hand, a cause that is unlikely to occur when a sensor abnormality occurs is expressed by, for example, the following equation (2) and is a negative value.

[Equation 2]

I=log₂[Σ(x*w)/{1−Σ(x*w)}+1]/log₂(2) (2)

The weight w used in calculating an information amount related to a high value abnormality or a low value abnormality that has not actually occurred may be larger than the weight w used in calculating an information amount related to a high value abnormality or a low value abnormality that has actually occurred.

The abnormality cause estimation unit 209 generates a matrix with M*2 rows and N columns from the failure part estimation database. The failure part estimation database (herein, a portion of M*2 is doubled to distinguish between high value/low value abnormalities) contains information amounts in association with M evaluation items and a high value abnormality and a low value abnormality. For this reason, the abnormality cause estimation unit 209 generates a matrix with M*2 rows and N columns by reading an information amount associated with the high value abnormality/low value abnormality determination unit 207 for each of the M evaluation items. The abnormality cause estimation unit 209 obtains a vector with N rows and 1 column, of which an element is certainty of an abnormality cause, by multiplying a vector with 1 row and M*2 rows, of which an element is a larger-the-better SN ratio of each evaluation item, by the generated matrix with M*2 rows and N columns. The abnormality cause estimation unit 209 estimates that an abnormality cause related to a row having a large element value in the obtained vector with N rows and 1 column is an abnormality cause generated in the plant 1. That is, the abnormality cause estimation unit 209 calculates, for each abnormality cause, a weighted sum of a larger-the-better SN ratio of each evaluation item and an information amount related to an abnormality of the item and estimates an abnormality cause based on the weighted sum.

The abnormality cause output display unit 210 outputs the abnormality cause estimated by the abnormality cause estimation unit 209 in order of certainty. Examples of outputting include displaying on a display, transmitting of data to the outside, printing on a sheet, and audio outputting.

<<About MT Method>>

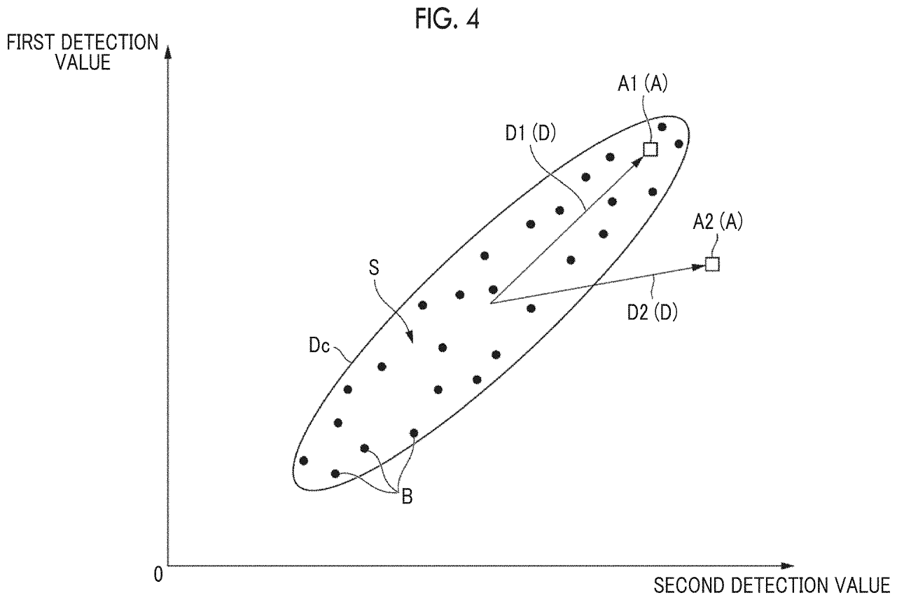

FIG. 4 is a conceptual diagram showing the concept of the Mahalanobis distance.

First, the outline of a plant monitoring method using the MT method will be described with reference to FIG. 4.

As shown in FIG. 4, it is assumed that the sensor value acquisition unit 201 of the plant monitoring device 20 acquires a first detection value and a second detection value of the plant 1 as a bundle B of detection values. For example, the first detection value is a “gas turbine output”, and the second detection value is a “boiler water level”. In the MT method, a data group, which is an aggregate of a plurality of bundles B of detection values, is set as a unit space S, which is a reference data group, and a Mahalanobis distance D of a bundle A of detection values acquired at a certain time point is calculated.

The Mahalanobis distance D is a distance that is weighted according to a variance and a correlation of detection values for the unit space S, and has a greater value as similarity with the data group for the unit space S becomes lower. Herein, the average of the Mahalanobis distances of the bundles B of detection values configuring the unit space S is 1, and in a case where the operation state of the plant 1 is normal, the Mahalanobis distance D of the bundle A of detection values is generally 4 or less. However, when the operation state of the plant 1 is abnormal, the value of the Mahalanobis distance D increases according to the degree of the abnormality.

For this reason, in the MT method, whether the operation state of the plant 1 is normal or abnormal is determined according to whether or not the Mahalanobis distance D is within a threshold value Dc determined in advance. For example, since a Mahalanobis distance D1 of a bundle A1 of detection values is equal to or smaller than the threshold value Dc, it is determined that the operation state of the plant 1 is normal at a time point when the bundle A1 of detection values is acquired. In addition, since a Mahalanobis distance D2 of a bundle A2 of detection values is greater than the threshold value Dc, it is determined that the operation state of the plant 1 is abnormal at a time point when the bundle A2 of detection values is acquired.

The threshold value Dc is preferably set to a value greater than the maximum Mahalanobis distance, for example, among respective Mahalanobis distances of the plurality of bundles B of detection values configuring the unit space S. In addition, at this time, it is preferable to determine the threshold value Dc in consideration of characteristics unique to the plant 1. The threshold value Dc may be changed by an operator via the plant monitoring device 20.

<<Operation of Plant Monitoring Device 20>>

Hereinafter, an operation of the plant monitoring device 20 will be described.

The plant monitoring device 20 collects bundles of detection values from the plant 1 and accumulates the bundles of detection values in the unit space storage unit 202 while the plant 1 operates normally before starting monitoring processing. The plant monitoring device 20 may acquire bundles of detection values at a normal time of another plant 1 having the same configuration as the plant 1, which is a monitoring target, and record the bundles in the unit space storage unit 202.

(Monitoring Processing of Plant 1)

When the unit space is recorded in the unit space storage unit 202 and a failure part estimation database is recorded in the failure part estimation database 208, the plant monitoring device 20 executes monitoring processing described below at predetermined monitoring times (for example, every hour).

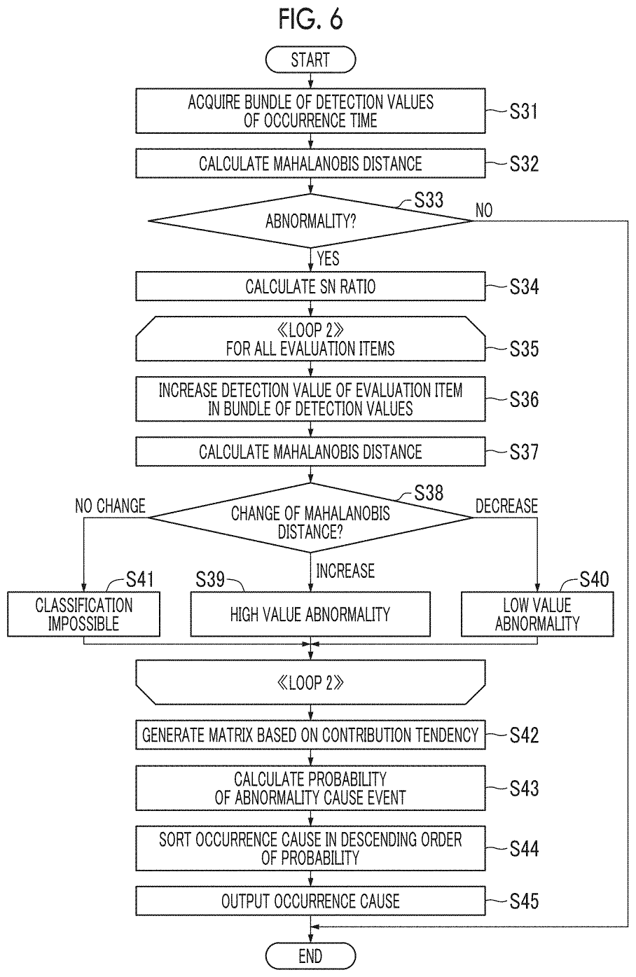

FIG. 6 is a flowchart showing monitoring processing of the plant 1 according to the first embodiment.

When the plant monitoring device 20 starts monitoring processing, the sensor value acquisition unit 201 acquires a bundle of detection values from the plant 1 (Step S31). The MD distance calculation unit 203 calculates a Mahalanobis distance based on a unit space stored by the unit space storage unit 202 with the bundle of detection values acquired in Step S31 as the specification (Step S32).

Next, the plant abnormality presence or absence determination unit 204 determines whether or not an abnormality has occurred in the plant 1 based on the Mahalanobis distance calculated in Step S32 (Step S33). In a case where the plant abnormality presence or absence determination unit 204 determines that an abnormality has not occurred in the plant 1 (Step S33: NO), the plant monitoring device 20 terminates the monitoring processing and stands by for the next monitoring time.

On the other hand, in a case where the plant abnormality presence or absence determination unit 204 determines that an abnormality has occurred in the plant 1 (Step S33: YES), the larger-the-better SN ratio calculation unit 205 calculates a larger-the-better SN ratio for each evaluation item through the Taguchi method based on the bundle of detection values acquired in Step S31 and on the Mahalanobis distance calculated in Step S32 (Step S34).

Next, the plant monitoring device 20 selects an evaluation item one by one and performs processing of Steps S36 to S41 described below for each evaluation item (Step S35).

First, the high value abnormality/low value abnormality determination unit 207 increases a sensor value selected in Step S35 by a predetermined amount, among the bundle of detection values acquired in Step S31 (Step S36). Next, the MD distance calculation unit 203 calculates a Mahalanobis distance based on the unit space stored by the unit space storage unit 202 with the bundle of detection values changed in Step S36 as the specification (Step S37).

The high value abnormality/low value abnormality determination unit 207 determines whether the Mahalanobis distance has increased, has decreased, or has not changed because of an increase in the detection value related to the abnormality sensor (Step S38). For example, the high value abnormality/low value abnormality determination unit 207 may determine that the Mahalanobis distance has not changed in a case where a difference in the Mahalanobis distance is equal to or smaller than a predetermined threshold value.

In a case where the Mahalanobis distance has increased (Step S38: increase), the high value abnormality/low value abnormality determination unit 207 determines that there is a high value abnormality in the abnormality sensor extracted in Step S35 (Step S39). On the other hand, in a case where the Mahalanobis distance has decreased (Step S38: decrease), the high value abnormality/low value abnormality determination unit 207 determines that there is a low value abnormality in the abnormality sensor extracted in Step S35 (Step S40). In a case where the Mahalanobis distance has not changed (Step S38: no change), the high value abnormality/low value abnormality determination unit 207 determines that classification cannot be performed for the abnormality sensor extracted in Step S35 (Step S41).

The abnormality cause estimation unit 209 generates a matrix with M*2 rows and N columns using the failure part estimation database 208 (Step S42). The abnormality cause estimation unit 209 obtains a vector with N rows and 1 column, of which an element is certainty of an abnormality cause, by multiplying a vector with 1 row and M*2 columns, in which the larger-the-better SN ratio of each evaluation item calculated in Step S34 and distinction between a high value abnormality and a low value abnormality are added, by the matrix with M*2 rows and N columns generated in Step S42 (Step S43). The item of the larger-the-better SN ratio that cannot be classified is set to 0. Next, the abnormality cause estimation unit 209 sorts each abnormality cause in descending order of certainty expressed by the obtained vector (Step S44). At this time, the abnormality cause estimation unit 209 sets the abnormality cause to a negative number in a case where an abnormality is less likely to occur than usual. Then, the abnormality cause output display unit 210 outputs the abnormality cause estimated by the abnormality cause estimation unit 209 in the sorted order (Step S45). For example, the abnormality cause output display unit 210 displays an abnormality cause having the highest certainty on the display and displays an abnormality cause having the second highest certainty on the display in a case where a display command of the next abnormality cause is received in response to an operation by a user. In addition, for example, the abnormality cause output display unit 210 prints a list of abnormality causes on a sheet in descending order of certainty.

<<Workings and Effects>>

As described above, in the first embodiment, in a case where it is determined that there is an abnormality based on a Mahalanobis distance, the plant monitoring device 20 estimates an abnormality cause based on an abnormality of each sensor value and on the failure part estimation database containing a relationship between a plurality of abnormality causes that can occur in the plant 1 and the plurality of sensor values for each abnormality.

Accordingly, the plant monitoring device 20 can estimate an abnormality cause by distinguishing whether there is an abnormality on a high value side or there is an abnormality on a low value side of each sensor value. Therefore, the plant monitoring device 20 can eliminate an event having a low probability of occurrence in an estimation result of an abnormality cause.

In addition, the failure part estimation database according to the first embodiment contains an information amount indicating an increase or a decrease in a probability of occurrence of the abnormality cause in association with a cause and a high value/low value abnormality sensor. Then, the plant monitoring device 20 acquires, for each of a plurality of sensor values, a value obtained by multiplying an information amount associated with an abnormality identified for the sensor value in the failure part estimation database by a larger-the-better SN ratio related to the sensor value and estimates an abnormality cause based on a total of acquired values. Accordingly, the certainty of an abnormality cause having a large information amount related to a sensor value having a high larger-the-better SN ratio is high, and the certainty of an abnormality cause having a small information amount related to a sensor value having a high larger-the-better SN ratio is low. Therefore, the plant monitoring device 20 can eliminate an event having a low probability of occurrence in an estimation result of an abnormality cause.

Other embodiments are not limited thereto. For example, the plant monitoring device 20 according to other embodiments may obtain a vector with N rows and 1 column, of which an element is certainty of an abnormality cause of an abnormality, by calculating cosine similarity between a vector with 1 row and M*2 columns, of which an element is a larger-the-better SN ratio of each sensor value, and each row vector of a matrix with M*2 rows and N columns, of which an element is a value of the failure part estimation database. The cosine similarity is a value obtained by dividing the inner product of vectors (a weighted sum of each larger-the-better SN ratio and an information amount related to an abnormality cause) by the product of norms of respective vectors. For example, the plant monitoring device 20 according to other embodiments may acquire, for each abnormality cause of an abnormality, a weighted sum of a larger-the-better SN ratio of each sensor value and an information amount of an abnormality cause, regardless of matrix calculation.

In addition, the failure part estimation database according to the first embodiment contains a positive information amount in association with an abnormality cause and an abnormality of a sensor value having a high probability of occurrence when the abnormality cause has occurred. On the other hand, the failure part estimation database according to the first embodiment contains a negative information amount in association with an abnormality cause and an abnormality of a sensor value having a high probability of non-occurrence when the abnormality cause has occurred. Accordingly, the plant monitoring device 20 can actively reduce the certainty of an abnormality cause having a high probability of non-occurrence. Therefore, the plant monitoring device 20 can eliminate an event having a low probability of occurrence in an estimation result of an abnormality cause.

Other embodiments are not limited thereto. For example, the failure part estimation database according to other embodiments may contain a zero information amount in association with an abnormality cause and an abnormality of a sensor value having a high probability of non-occurrence when the abnormality cause has occurred. Also in this case, the certainty of an abnormality cause is not considerably reduced compared to a case of having a negative information amount, but an event having a low probability of occurrence of an abnormality cause in an estimation result can be eliminated by distinguishing abnormalities of respective sensor values and estimating an abnormality cause.

In addition, the plant monitoring device 20 according to the first embodiment updates the failure part estimation database such that, based on a bundle of detection values when an abnormality cause has occurred, an information amount associated with an identified abnormality is increased, and an information amount associated with an abnormality which has not been identified is decreased for each sensor value. Accordingly, the plant monitoring device 20 can automatically generate the failure part estimation database having an information amount related to an opposite direction. Other embodiments are not limited thereto, and a negative information amount may be manually input by an operator.

In addition, the plant monitoring device 20 according to the first embodiment updates an information amount for at least one abnormality sensor having a high larger-the-better SN ratio among a plurality of sensor values. Accordingly, the plant monitoring device 20 can add precision to an information amount of each sensor value in the failure part estimation database.

Although one embodiment has been described hereinbefore in detail with reference to the drawings, a specific configuration is not limited to the description above and can be subject to various design changes. That is, in other embodiments, the procedures of processing described above may be changed as appropriate. In addition, some of the processing may be executed in parallel.

<Computer Configuration>

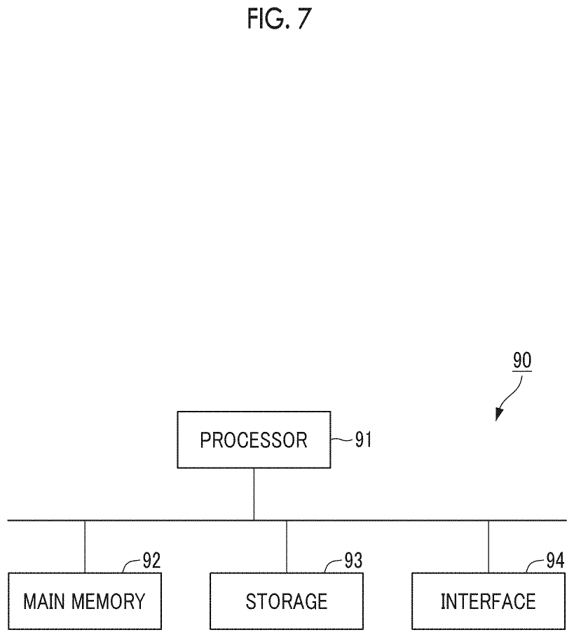

FIG. 7 is a schematic block diagram showing a configuration of a computer according to at least one embodiment.

A computer 90 includes a processor 91, a main memory 92, a storage 93, and an interface 94.

The plant monitoring device 20 described above is mounted on the computer 90. An operation of each processing unit described above is stored in a form of a program in the storage 93. The processor 91 reads the program from the storage 93, deploys the program in the main memory 92, and executes the processing in accordance with the program. In addition, the processor 91 secures a storage area, which corresponds to each storage unit described above, in the main memory 92 in accordance with the program. Examples of the processor 91 include a central processing unit (CPU), a graphics processing unit (GPU), and a microprocessor.

The program may be a program for realizing some of the functions performed by the computer 90. For example, the program may be a program that performs the functions in combination with other programs already stored in the storage or in combination with other programs installed in other devices. In other embodiments, the computer 90 may include a custom large scale integrated circuit (LSI) such as a programmable logic device (PLD), in addition to the configuration or instead of the configuration. Examples of the PLD include a programmable array logic (PAL), a generic array logic (GAL), a complex programmable logic device (CPLD), and a field programmable gate array (FPGA). In this case, some or all of the functions realized by the processor 91 may be realized by the integrated circuit. Such an integrated circuit is also included in an example of the processor.

Examples of the storage 93 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 93 may be an internal medium directly connected to a bus of the computer 90, or may be an external medium connected to the computer 90 via the interface 94 or a communication line. In addition, in a case where the program is distributed to the computer 90 via a communication line, the computer 90 that has received the distribution may deploy the program in the main memory 92 and execute the processing. In at least one embodiment, the storage 93 is a non-transitory tangible storage medium.

In addition, the program may be a program for realizing some of the functions described above. Further, the program may be a program that realizes the functions described above in combination with other programs already stored in the storage 93, that is, a so-called difference file (difference program).

The plant monitoring device 20 according to the embodiment described above may be configured by a single computer 90, and the configuration of the plant monitoring device 20 may be a configuration where a plurality of computers 90 are divided and disposed and function as the plant monitoring device 20 as the plurality of computers 90 cooperate with each other.

<Appendix>

The plant monitoring device, the plant monitoring method, and the program described in each embodiment can be understood, for example, as follows.

(1) According to a first aspect, a plant monitoring device (20) has a sensor value acquisition unit (201) that acquires a bundle of detection values for each of a plurality of sensor values related to a plant (1), a distance calculation unit (203) that acquires a Mahalanobis distance of the bundle of detection values acquired by the sensor value acquisition unit (201) with a unit space configured by collecting a bundle of detection values for each of the plurality of sensor values as reference, a plant abnormality presence or absence determination unit (204) that determines whether an operation state of the plant (1) is normal or abnormal according to whether or not the Mahalanobis distance is within a predetermined threshold value, a high value abnormality/low value abnormality determination unit (207) that identifies, in a case where the operation state of the plant is determined to be abnormal, whether at least one sensor value estimated to be a cause among the bundle of detection values is a high value abnormality, which is an abnormality caused by a high detection value, or a low value abnormality, which is an abnormality caused by a low detection value, an abnormality cause estimation unit (209) that estimates, for the at least one sensor value, an abnormality cause based on distinction between the low value abnormality and the high value abnormality and on a failure part estimation database containing a relationship between a plurality of abnormality causes which can occur in the plant and the plurality of sensor values for each tendency, and an output unit (210) that outputs the estimated abnormality cause.

Accordingly, the plant monitoring device can estimate an abnormality cause by distinguishing whether there is an abnormality on the high value side or there is an abnormality on the low value side of each sensor value. Therefore, the plant monitoring device can eliminate an event having a low probability of occurrence in an estimation result of an abnormality cause.

To “acquire” is to newly obtain a value. For example, to “acquire” includes receiving a value, receiving an input of a value, reading a value from the storage medium, and calculating another value from one value.

To “identify” is to determine a second value that can take on a plurality of values using a first value. For example, to “identify” includes calculating the second value from the first value, reading the second value corresponding to the first value with reference to the failure part estimation database, searching for the second value with the first value as a query, and selecting the second value from a plurality of candidates based on the first value.

(2) According to a second aspect, the plant monitoring device (20) according to the first aspect may include a larger-the-better SN ratio calculation unit (205) that calculates larger-the-better SN ratios of the plurality of sensor values based on the bundle of detection values. The failure part estimation database contains an information amount indicating an increase or a decrease in a probability of occurrence of an abnormality cause in association with an abnormality cause and a sensor value. The abnormality cause estimation unit (209) may acquire, for each of the plurality of sensor values, a value obtained by multiplying an information amount associated with distinction between the low value abnormality and the high value abnormality, which is made for the sensor value in the failure part estimation database, by the larger-the-better SN ratio related to the sensor value and may estimate the abnormality cause based on a total of the acquired values.

Accordingly, the certainty of an abnormality cause having a large information amount related to a sensor value having a high larger-the-better SN ratio is high, and the certainty of an abnormality cause having a small information amount related to a sensor value having a high larger-the-better SN ratio is low. Therefore, the plant monitoring device can eliminate an event having a low probability of occurrence in an estimation result of an abnormality cause.

(3) According to a third aspect, in the plant monitoring device (20) according to the first or second aspect, in the failure part estimation database, a positive information amount may be associated with an abnormality cause and an abnormality having a high probability of occurrence when the abnormality cause has occurred, among a low value abnormality and a high value abnormality, and a negative information amount may be associated with an abnormality cause and an abnormality having a high probability of non-occurrence when the abnormality cause has occurred, among the low value abnormality and the high value abnormality.

Accordingly, the plant monitoring device can actively reduce the certainty of the abnormality cause having a high probability of non-occurrence. Therefore, the plant monitoring device can eliminate an event having a low probability of occurrence in an estimation result of an abnormality cause.

(4) According to a fourth aspect, in the plant monitoring device according to the third aspect, in the failure part estimation database, an absolute value of the information amount associated with the abnormality having the high probability of non-occurrence when the abnormality cause has occurred, among the low value abnormality and the high value abnormality, may be larger than an absolute value of the information amount associated with the abnormality having the high probability of occurrence when the abnormality cause has occurred.

(5) According to a fifth aspect, there is provided a program that causes a computer to execute a step of acquiring a bundle of detection values for each of a plurality of sensor values related to a plant, a step of acquiring a Mahalanobis distance of the bundle of detection values acquired by the acquisition unit with a unit space configured by collecting a bundle of detection values for each of the plurality of sensor values as reference, a step of determining whether an operation state of the plant is normal or abnormal according to whether or not the Mahalanobis distance is within a predetermined threshold value, a step of identifying, in a case where the operation state of the plant is determined to be abnormal, whether at least one sensor value estimated to be a cause among the bundle of detection values is a high value abnormality, which is an abnormality caused by a high detection value, or a low value abnormality, which is an abnormality caused by a low detection value, a step of estimating, for the at least one sensor value, an abnormality cause based on distinction between the low value abnormality and the high value abnormality and on a failure part estimation database containing a relationship between a plurality of abnormality causes which can occur in the plant and the plurality of sensor values, and a step of outputting the estimated abnormality cause.

### INDUSTRIAL APPLICABILITY

The plant monitoring device can more reliably estimate a true cause of a failure by setting information of an event having a low probability that a cause occurs because of an abnormality of a sensor to a negative value.

### REFERENCE SIGNS LIST

1 plant
20 plant monitoring device
201 sensor value acquisition unit
202 unit space storage unit
203 MD distance calculation unit
204 plant abnormality presence or absence determination unit
205 larger-the-better SN ratio calculation unit
206 abnormality sensor extraction unit
207 high value abnormality/low value abnormality determination unit
208 failure part estimation database
209 abnormality cause estimation unit
210 abnormality cause output display unit

1. A plant monitoring device comprising:
a sensor value acquisition unit that acquires a bundle of detection values for each of a plurality of sensor values related to a plant;
a distance calculation unit that acquires a Mahalanobis distance of the acquired bundle of detection values with a unit space configured by collecting the bundle of detection values for each of the plurality of sensor values as reference;
a plant abnormality presence or absence determination unit that determines whether an operation state of the plant is normal or abnormal according to whether or not the Mahalanobis distance is within a predetermined threshold value;
a high value abnormality/low value abnormality determination unit that identifies, in a case where the operation state of the plant is determined to be abnormal, whether at least one sensor value estimated to be a cause among the bundle of detection values is a high value abnormality, which is an abnormality caused by a high detection value, or a low value abnormality, which is an abnormality caused by a low detection value;
an abnormality cause estimation unit that estimates, for the at least one sensor value, an abnormality cause based on distinction between the low value abnormality and the high value abnormality and on a failure part estimation database containing a relationship between a plurality of abnormality causes, which occurs in the plant, and the plurality of sensor values; and
an output unit that outputs the estimated abnormality cause.

2. The plant monitoring device according to claim 1, further comprising:
an SN ratio calculation unit that calculates SN ratios of the plurality of sensor values based on the bundle of detection values,
wherein the failure part estimation database contains an information amount indicating an increase or a decrease in a probability of occurrence of an abnormality cause in association with an abnormality cause and a sensor value, and
the abnormality cause estimation unit acquires, for each of the plurality of sensor values, a value obtained by multiplying the information amount associated with the distinction between the low value abnormality and the high value abnormality, which is made for the sensor value in the failure part estimation database, by a larger-the-better SN ratio related to the sensor value and estimates the abnormality cause based on a total of the acquired values.

3. The plant monitoring device according to claim 1,
wherein in the failure part estimation database, when a high value abnormality/low value abnormality occurs, a positive information amount is associated with an abnormality of which an abnormality cause is more likely to occur than usual, and a negative information amount is associated with an abnormality of which an abnormality cause is less likely to occur than usual.

4. A plant monitoring method comprising:
a step of acquiring a bundle of detection values for each of a plurality of sensor values related to a plant;
a step of acquiring a Mahalanobis distance of the acquired bundle of detection values with a unit space configured by collecting the bundle of detection values for each of the plurality of sensor values as reference;
a step of determining whether an operation state of the plant is normal or abnormal according to whether or not the Mahalanobis distance is within a predetermined threshold value;
a step of identifying, in a case where the operation state of the plant is determined to be abnormal, whether at least one sensor value estimated to be a cause among the bundle of detection values is a high value abnormality, which is an abnormality caused by a high detection value, or a low value abnormality, which is an abnormality caused by a low detection value;
a step of estimating, for the at least one sensor value, an abnormality cause based on distinction between the low value abnormality and the high value abnormality and on a failure part estimation database containing a relationship between a plurality of abnormality causes, which occurs in the plant, and the plurality of sensor values; and
a step of outputting the estimated abnormality cause.

5. A program for causing a computer to execute:
a step of acquiring a bundle of detection values for each of a plurality of sensor values related to a plant;
a step of acquiring a Mahalanobis distance of the acquired bundle of detection values with a unit space configured by collecting the bundle of detection values for each of the plurality of sensor values as reference;
a step of determining whether an operation state of the plant is normal or abnormal according to whether or not the Mahalanobis distance is within a predetermined threshold value;
a step of identifying, in a case where the operation state of the plant is determined to be abnormal, whether at least one sensor value estimated to be a cause among the bundle of detection values is a high value abnormality, which is an abnormality caused by a high detection value, or a low value abnormality, which is an abnormality caused by a low detection value;
a step of estimating, for the at least one sensor value, an abnormality cause based on distinction between the low value abnormality and the high value abnormality and on a failure part estimation database containing a relationship between a plurality of abnormality causes, which occurs in the plant, and the plurality of sensor values; and
a step of outputting the estimated abnormality cause.
